(19) United States
(12) Patent Application Publication
(10) Pub. No.: US 2025/0131538 A1
(43) Pub. Date: Apr. 24, 2025

(54) DYNAMIC PRIVACY PROTECTION FROM A CALIBRATED CAMERA SYSTEM

(71) Applicant: Genetec Inc., Montreal (CA)

(72) Inventor: Edvin ATTEBO, Vienna (AT)

(21) Appl. No.: 18/493,473

(22) Filed: Oct. 24, 2023

(51) Int. Cl. G06T 5/00; G06T 7/50; G06T 7/62; G06T 7/73; G06V 10/22; G06V 20/40; G06V 20/52; H04N 7/18

(52) U.S. Cl. CPC G06T 5/70; G06T 7/50; G06T 7/62; G06T 7/73; G06V 10/225; G06V 20/41; G06V 20/52; H04N 7/181; G06T 2207/10016; G06T 2207/30201; G06T 2207/30232

(57) ABSTRACT

A system and method for applying a mask to an object in a set of images. A computing system identifies a geometry of the object in an image from the set of images. Privacy thresholds are determined for each of a plurality of points on the object in the image using the geometry of the object. A mask is applied to the object in the image using the privacy thresholds, such that the mask provides different privacy at different points on the object. The geometry includes an orientation of the object and/or a depth of view of the object.

### FIELD

The present teachings relate generally to imaging systems and, more particularly, to systems and methods for processing image data for privacy considerations.

### BACKGROUND

The use of video imaging systems is widespread to monitor private and public areas. Video imaging systems (also referred to as video surveillance systems, video systems, etc.) produce video in which objects such as people, license plates, and other objects may be identifiable. Such video can be repeatedly reviewed, copied, and distributed, thus making exposure of private information concerning. In general, the public may have no knowledge of, or control over, the handling and use of video produced by such systems. This may lead to opposition to video surveillance, even though such systems can have numerous benefits such as for combatting crime and terrorism.

An increasing demand for privacy has come from regulations such as Europe's General Data Protection Regulation (GDPR), the California Consumer Privacy Act (CCPA), Canada's Personal Information Protection and Electronic Documents Act (PIPEDA), Israel's Data Security Regulation, the African Union's regulation, as well as many others. Accordingly, protecting the privacy of people and other objects of interest is desirable.

Protecting a person's privacy involves making them (or other identifying object, such as a license plate) unrecognizable in the image/video. A common approach to achieve this is to apply a mask so that the person/object is no longer identifiable. The choice of mask is up to the designer but can be achieved by applying a patch of color, blurring, pixelation, a filter, scrabbling pixels in that region, etc., although not limited thereto.

In conventional solutions, “object detectors” have been used to detect sensitive image areas, such as a face, a license plate, etc. These sensitive areas are then masked (obscured), for example, by pixelization. Object detectors are discussed in Martinez-Ponte et.al., “Robust Human Face Hiding Ensuring Privacy”, Proceedings of the International Workshop on Image Analysis for Multimedia Interactive Services, 2005, as well as in US Pat. Pub. No. 2010/0183227, entitled “Person detecting apparatus and method and privacy protection system employing the same”. However, object detectors may lack reliability in determining what and/or when objects should be masked, making them ill-suited for many privacy protection scenarios.

Conventional solutions may require manual intervention to select an object or element of the video to be redacted. Such approaches increase labor and costs, especially when there is a high volume of video data.

In some solutions, a model may be built of the background in the camera view over time to detect areas that are unusual or moving so the detected areas can be masked, as discussed in WO 2011014901A2, entitled “Method for video analysis”. In addition, US Pub. No. 2023/0247250, entitled “Systems and methods for producing a privacy-protected video clip”, discloses the use of a background model. However, because such processes may attempt to learn and improve the background of the scene continuously, they may require processing time to reliably distinguish background from foreground. This may consume significant computing resources that grows with the number of cameras used in the system.

It is desirable to protect the privacy of an object (e.g., person or any other object, including objects which might serve to identify a person, such as a vehicle) but at the same time keep important information in the image. Which information is important depends on the situation but could be, for example, the type of object, its movement, and the surrounding area. For example, in the case where the goal is to protect the identity of a person, one could obscure the person with a mask of a certain size (e.g., a kernel). In image processing, a kernel, convolution matrix, mask, etc. can be a small matrix used for blurring, sharpening, embossing, edge detection, and more. This may be accomplished by doing a convolution between the kernel and an image, as appreciated by one skilled in the art. Or more simply, when each pixel in the output image is a function of the nearby pixels (including itself) in the input image, the kernel is that function.

The mask size may determine how much privacy the object gets, so the mask should be of the right size to achieve the desired privacy. If the mask size is too big, it will remove important information from the object's surroundings. On the other hand, if the mask size is too small, the object could still have distinguishing features and hence be identifiable.

Therefore, it would be beneficial to have an alternative system and method for dynamic privacy protection from a calibrated camera system.

### SUMMARY

The needs set forth herein as well as further and other needs and advantages are addressed by the present embodiments, which illustrate solutions and advantages described below.

The present teachings relate to applying a mask to an object in an image or set of images (e.g., video). The mask is applied using privacy thresholds determined using a geometry of the object. For example, the geometry can include an orientation of the object and/or a depth of view of the object. In this way, the mask provides different privacy at different points on the object.

One embodiment of a system according to the present teachings includes, but is not limited to, a video system having a set of images generated by a camera and a computing system adapted to apply a mask to an object in the set of images. The computing system is adapted to identify a geometry of the object in an image from the set of images. The computing system is adapted to determine privacy thresholds for each of a plurality of points on the object in the image using the geometry of the object. The computing system is adapted to apply the mask to the object in the image using the privacy thresholds, such that the mask provides different privacy at different points on the object.

In one embodiment, the geometry comprises a depth of view of the object.

In one embodiment, the depth of view is determined using projections of points on the object in the image to world coordinates.

In one embodiment, the projections are determined by: identifying a first point and a second point on the object; calculating a first point distance from the camera to a projection of the first point on a ground in world coordinates; calculating a second point distance from the camera to a projection of the second point in world coordinates, the projection of the second point on an orthogonal that is orthogonal to the ground at the projection of the first point; calculating distances from the camera to the plurality of points, the plurality of points along the orthogonal from the projection of the first point to the projection of the second point, using the first point distance and the second point distance. The privacy thresholds for each of the plurality of points are determined using their associated distances.

In one embodiment, the geometry comprises an orientation of the object.

In one embodiment, the orientation includes one or more expected sizes of the object.

In one embodiment, the computing system comprises a plurality of processors in communication over a network.

In one embodiment, a system according to the present teachings includes a video surveillance system, having a plurality of monitors and a plurality of cameras. The set of images includes a live video stream from one of the plurality of cameras. The mask includes pixelation.

In one embodiment, the object includes a person, and the mask obscures a face of the person.

In one embodiment, a limit is applied to at least one of the privacy thresholds using a type of the object. The limit includes applying less or no privacy below a certain height on the object, such that an unnecessarily high amount of privacy is avoided if the object includes overlapping objects.

In one embodiment, a limit is applied to at least one of the privacy thresholds using a type of the object. The limit includes applying privacy above a certain height on the object, such that an unnecessarily low amount of privacy is avoided if the object is not completely in the image.

One embodiment of a system according to the present teachings includes, but is not limited to, a video system having a set of images generated by a camera and a computing system adapted to apply a mask to an object in the set of images. The computing system is adapted to identify a geometry of the object in an image from the set of images. The computing system is adapted to determine privacy thresholds for each of a plurality of points on the object in the image using the geometry of the object. The computing system is adapted to apply the mask to the object in the image using the privacy thresholds, such that the mask provides different privacy at different points on the object. The geometry includes an orientation of the object and/or a depth of view of the object.

In one embodiment, the depth of view is determined using projections of points on the object in the image to world coordinates.

In one embodiment, the orientation includes one or more expected sizes of the object.

In one embodiment, the computing system is adapted to: identify a first point and a second point on the object; calculate a first point distance from the camera to a projection of the first point on a ground in world coordinates; calculate a second point distance from the camera to a projection of the second point in world coordinates, the projection of the second point on an orthogonal that is orthogonal to the ground at the projection of the first point; calculate distances from the camera to the plurality of points, the plurality of points along the orthogonal from the projection of the first point to the projection of the second point, using the first point distance and the second point distance. The privacy thresholds for each of the plurality of points are determined using their associated distances.

In one embodiment, the first and second points are identified using a bounding box on the object. The first point is a bottom point on the object and the second point is a top point on the object. The privacy thresholds are determined using a linear function of distances to the camera.

One embodiment of a method according to the present teachings includes, but is not limited to, a method of applying privacy to an image, including: providing a set of images generated by a camera; providing a computing system adapted to apply a mask to an object in the set of images; identifying with the computing system a geometry of the object in an image from the set of images; determining privacy thresholds for each of a plurality of points on the object in the image using the geometry of the object; applying the mask to the object in the image using the privacy thresholds, such that the mask provides different privacy at different points on the object. The geometry includes an orientation of the object and/or a depth of view of the object.

Other embodiments of the system and method are described in detail below and are also part of the present teachings.

For a better understanding of the present embodiments, together with other and further aspects thereof, reference is made to the accompanying drawings and detailed description, and its scope will be pointed out in the appended claims.

### BRIEF DESCRIPTION OF THE DRAWINGS

FIG. 1 is an illustration of two boxes placed at different positions in an image.

FIG. 2 is a graph showing variation in the amount of privacy protection applied based on the position of an object.

FIG. 3 is another graph of an object with different heights and positions in the world frame.

FIG. 4 is an illustration of a setup with a camera, an object, and a plane.

FIG. 5 is an illustration of an image projection according to one embodiment of the present teachings.

FIG. 6 is an illustration of two people overlapping each other in the image plane.

FIG. 7 is a flowchart according to one embodiment of the present teachings.

FIG. 8 is one embodiment of a system according to the present teachings.

FIG. 9 is an illustration of an example pixelation according to the present teachings.

### DETAILED DESCRIPTION

The present teachings are described more fully hereinafter with reference to the accompanying drawings, in which the present embodiments are shown. The following description is presented for illustrative purposes only and the present teachings should not be limited to these embodiments. Any computer configuration and architecture satisfying the speed and interface requirements herein described may be suitable for implementing the system and method of the present embodiments.

In compliance with the statute, the present teachings have been described in language more or less specific as to structural and methodical features. It is to be understood, however, that the present teachings are not limited to the specific features shown and described, since the systems and methods herein disclosed comprise preferred forms of putting the present teachings into effect.

For purposes of explanation and not limitation, specific details are set forth such as particular architectures, interfaces, techniques, etc. in order to provide a thorough understanding. In other instances, detailed descriptions of well-known devices, circuits, and methods are omitted so as not to obscure the description with unnecessary detail.

A “computing system” may provide functionality for the present teachings. The computing system may include software executing on computer readable media that may be logically (but not necessarily physically) identified for particular functionality (e.g., functional modules). The computing system may include any number of computers/processors, which may communicate with each other over a network. The computing system may be in electronic communication with a datastore (e.g., database) that stores control and data information. Forms of at least one computer-readable medium include, but are not limited to, disks, hard drives, random access memory, programmable read only memory, or any other medium from which a computer can read.

Generally, all terms used in the claims are to be interpreted according to their ordinary meaning in the technical field, unless explicitly defined otherwise herein. All references to a/an/the element, apparatus, component, means, step, etc. are to be interpreted openly as referring to at least one instance of the element, apparatus, component, means, step, etc., unless explicitly stated otherwise. The steps of any method disclosed herein do not have to be performed in the exact order disclosed, unless explicitly stated. The use of “first”, “second,” etc. for different features/components of the present disclosure are only intended to distinguish the features/components from other similar features/components and not to impart any order or hierarchy to the features/components.

To aid the Patent Office and any readers of any patent issued on this application in interpreting the claims appended hereto, it is noted that none of the appended claims or claim elements are intended to invoke 35 U.S.C. 112 (f) unless the words “means for” or “step for” are explicitly used in the particular claim.

Recitations of numerical ranges by endpoints include all numbers within that range (e.g., 1 to 5 includes 1, 1.5, 2, 2.75, 3, 3.80, 4, 5, etc.). Where a range of values is “greater than”, “less than”, etc., of a particular value, that value is included within the range.

Any direction referred to herein, such as “top,” “bottom,” “left,” “right,” “upper,” “lower,” “above,” below,” and other directions and orientations are described herein for clarity in reference to the figures and are not to be limiting of an actual device or system or use of the device or system. Many of the devices, articles or systems described herein may be used in a number of directions and orientations.

Any citation to references in this disclosure and during the prosecution thereof is made out of an abundance of caution. No citation should be construed as an admission that the cited reference qualifies as prior art or comes from an area that is analogous or directly applicable to the present teachings.

The present teachings relate to applying a mask to an object in an image or set of images (video). The mask is applied using privacy thresholds determined using a geometry of the object. In this way, the mask provides different privacy at different points on the object.

In one embodiment, the present teachings disclose correlating a distance between the source of images (e.g., camera) and the object (e.g., points on people/objects in the 3D world). This allows, for example, to provide equal privacy protection regardless of position and size of the object. In this way, a mask size can be regulated for different points on the person/object and thus, the amount of privacy applied.

Cameras capture the three-dimensional world (3D) in a two-dimensional image (2D). The projection matrix of a camera gives the relationship between 3D points in the world and its perspective projection on the image plane. This projection matrix is composed of intrinsic and extrinsic parameters. Intrinsic parameters may depend on the camera and the extrinsic parameters may depend on its location and orientation in the world. Depending on the characteristics of these intrinsic and extrinsic parameters, an object will to some degree change in size and position on the image plane, e.g., when moving in the world frame. This makes the problem of finding adequate privacy protection for objects of different sizes and positions challenging.

In the following, two exemplary approaches are discussed for applying privacy, namely, 1) using a constant kernel size, and 2) privacy protection from perspective in image plane. Both approaches have shortcomings.

A first approach of applying privacy is constant kernel size. This is a relatively simple approach to protect privacy of an object by applying the same privacy method over an entire object. To illustrate this, one could consider the case where a kernel of fixed size is used to pixelate an object. One shortcoming of this method is that the further an object is from the camera, the more over-pixelated it becomes and hence does not protect privacy equally.

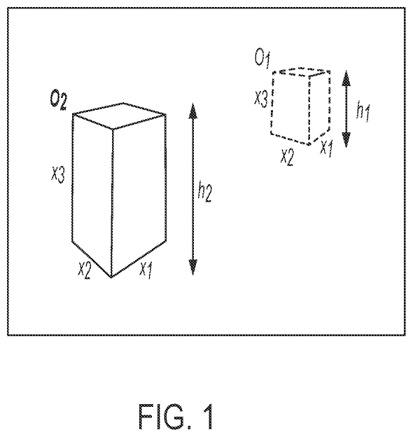

Referring now to FIG. 1, shown is an illustration of two boxes (O₁, O₂) placed at different positions in an image. The boxes have the same dimensions, where h₂ is the height of box O₂ and correspondingly h₁ is the height of O₁. The left box O₂ appears bigger due to the perspective as it is closer to the camera. Since both boxes have the same dimensions but appear to be of different sizes in the image plane, O₂ has a higher resolution and shows more distinguishing details than O₁ and therefore can have a larger pixelation kernel size. Accordingly, even though the boxes have the same dimensions, when placed at different locations in the world frame (e.g., world coordinates) as shown in the image plane, they will result in different privacy settings. However, it may be undesirable to use the same privacy settings to protect the privacy of both boxes at the same time, since a larger kernel applied to both boxes may obstruct contextual information around the farther box O₁, and a smaller kernel applied to both boxes may result in the closer box O₂ not being sufficiently pixelated, thereby defeating the privacy protection afforded by the pixelation.

For the sake of simplicity, one can discard the difference in resolution throughout an object and only consider the change of resolution with respect to different locations on the image plane. The kernel size is then only correlated to the image coordinates with a linear relationship. This dynamic adaptation of the kernel size is lacking in this simple constant kernel size solution.

One object of the present teachings is to have an appropriate amount of privacy regardless of object resolution.

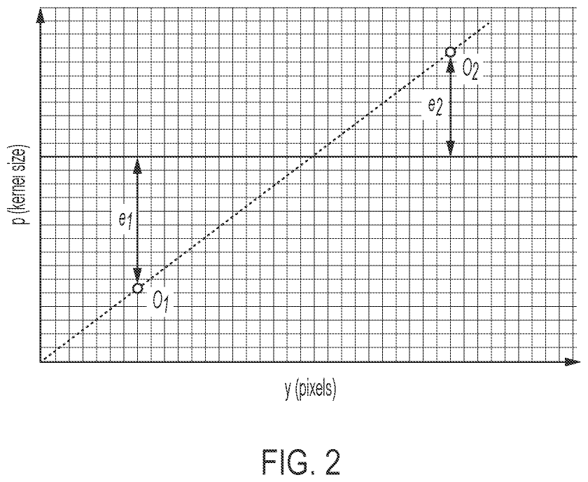

Referring now to FIG. 2, shown is a graph showing variation in the amount of privacy protection applied based on the position of an object. O₁ and O₂ represent the same point on two identical objects (e.g., the boxes in FIG. 1) at different positions in the image plane. The x-axis represents the y-coordinate of the points in the image plane and the y-axis represents an optimal kernel size, used for privacy protection. The horizontal line is a constant kernel size applied on the objects and the errors e₁ and e₂ are the differences in kernel size between the constant kernel and an optimal one.

One can see that for the errors e₂ and e₁ to become zero, the object sizes need to remain constant in the image plane due to their positions in the world frame. In many situations, this will not be true. Additionally, knowing how much privacy to apply can be difficult without the perspective of the system and can become an inconvenient manual procedure.

A second approach of applying privacy is privacy protection from perspective in image plane. One could use a perspective matrix to capture a linear correlation between size and position of an object in the image. A function can be used to scale the kernel size during pixelation. The errors e₁ and e₂ from FIG. 2 would then become zero. Problems arise with this approach when there is a change of resolution throughout the same object. The resolution in the image plane will have a linear correlation, but only for the objects that lie on the same plane in the world frame.

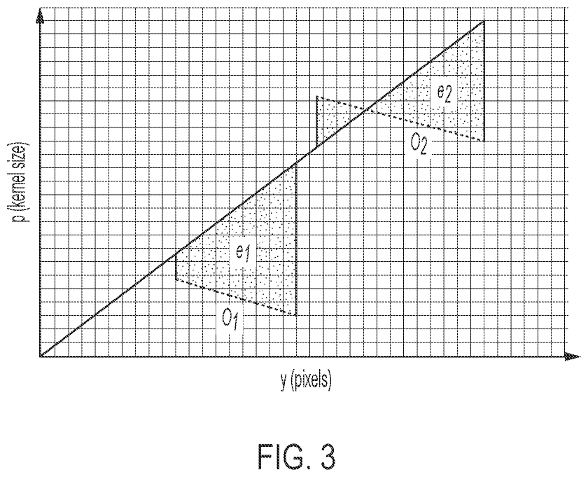

Referring now to FIG. 3, shown is another graph of an object (O₁, O₂) with different heights and positions in the world frame. The x-axis represents the y-coordinate of the objects in the image plane and the y-axis represents an optimal kernel size used for privacy protection. The slope intersecting O₂ is a privacy method that determines the kernel size applied to the objects. The errors e₁ and e₂ are the differences in kernel sizes between the privacy method and the optimal one throughout the objects.

If one assumes an optimal privacy function exists for applying a mask to the objects, with respect to the distance from the world frame (world coordinates) to the camera, this optimal privacy function for the objects can be obtained by taking distances from the entire bodies in the world frame to the camera and mapping it to a kernel size. The linear function used for the kernel size is displayed as a black line intersecting O₂. The linear function will capture the perspective for all the points lying at a height over the ground plane. One can see that points on the objects that are above the height have too little privacy while points under the height have too much. Of course, different use cases may warrant different levels of pixelation as well, so different privacy functions would be needed.

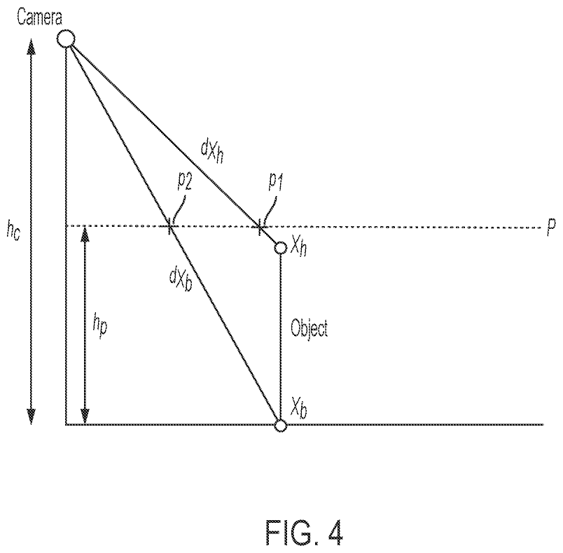

Referring now to FIG. 4, shown is an illustration of a setup with a camera, an object, and a plane P. Points p₁ and p₂ are the points of intersection between P and the line from the camera to point Xₕ and X_{b} on the object. h_{c} is the height from the ground plane to the camera and hₚ is the height from the ground plane to the plane P.

FIG. 4 demonstrates shortcomings in prior solutions by showing the distance of an object to the camera in the world frame (world coordinates) and the distance used by this privacy approach. The plane P represents all points in the world frame that will have adequate privacy in the image plane when using this linear function. The function can be calibrated to obtain perfect privacy for all points at the plane P, with height hₚ above the ground plane. The kernel size can be calculated by taking a function of the distance between the camera and the point in world frame that intersects P. For example, the distance between point p₁ and the camera is used to get the privacy for point Xₕ. This distance can differ from the actual distance d_{Xh} which will result in an exaggerated privacy. The effect is even larger for the point X_{b}.

The present teachings address shortcomings found in the two approaches, namely, 1) using a constant kernel size, and 2) privacy protection from perspective in image plane. One object of the present teachings it to apply adequate privacy to objects in an image or video taking into consideration object geometry, such as location and orientation.

Using a geometry of the object, privacy thresholds can be determined for each of a plurality of points on the object. The mask can then be applied using the privacy thresholds, such that the mask provides different privacy at different points on the object. For example, the geometry may include a perceived depth of view of the object, which may be determined using projections of points on the object in the image to world coordinates. In a non-limiting alternative embodiment, the geometry may include an orientation of the object, such as one or more expected sizes of the object (e.g., height of a person, size of a vehicle, size of a license plate, etc.), an actual orientation for the object (e.g., persons standing up, lying down, leaning, etc.), and the like. In a further non-limiting alternative embodiment, the geometry may include using a depth map associated with one or more objects which identify the perceived depth of the object relative to the camera at different points on the object. Other different embodiments are also considered, which may combine any one or more aspects of the alternatives described herein, without limitation.

According to one embodiment for applying privacy protection to an object in an image, bottom and top points of the object can be obtained. To do this, one can use an object detection bounding box, segmentation, or other techniques that are feasible to get the borders of the object, as would be appreciated by one skilled in the art. The bottom and top points are then calculated by taking the minimum and maximum height values of the borders respectively. One can choose to centralize the points with the minimum and maximum width values, depending on the type of object and method used to obtain the borders.

Given the perspective matrix of the camera, it is possible to project the bottom point in the image plane to the ground plane in the world frame (e.g., to world coordinates). The distance from the world coordinate of the projected bottom point to the camera can be calculated with relatively simple trigonometry, as would be appreciated by one skilled in the art.

A line from the projected bottom point, normal to the ground plane, can then back projected to the image. The height of the image projection of the line can be set equal to the height of the top point. Using these, the height of the line in the world frame can be obtained. This gives an approximate mapping of the top point in the image plane to the point on the object in the world frame. The distance between the top point to the camera in the world frame can be calculated in a similar manner as the bottom point.

The distances from all the points between the top and bottom points to the camera in the world frame can be interpolated. Privacy may be determined by a linear function with respect to the distance in the world frame from points on the object to the camera.

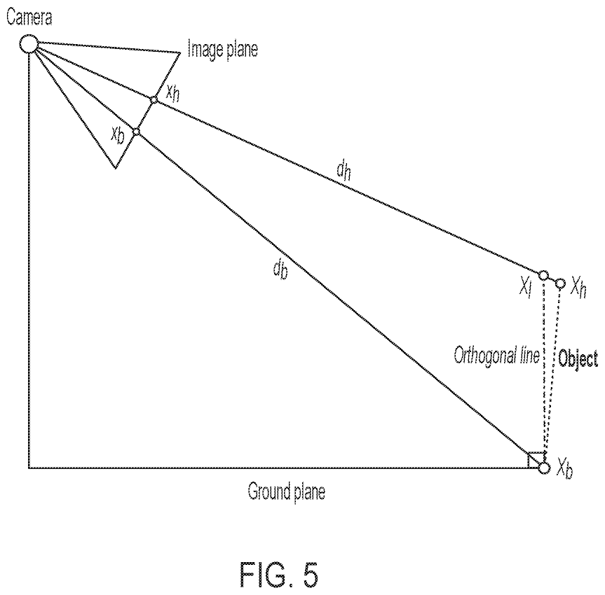

The following describes one embodiment of the present teachings from a more technical point of view, which will be discussed later with reference to FIG. 5.

1. From an image, object bottom and top points x_{b} and xₕ, with coordinates (u_{b}, v_{b}) and (uₕ, vₕ) are obtained by taking the maximum and minimum values of its borders. The borders can for example be constructed from a segmentation.

2. An imaging system (e.g., camera) has an associated projection matrix P as,

$$x = P [ \begin{matrix}X \\ 1\end{matrix} ] ,$$

$$with ,$$

$$x = \begin{matrix}u \\ v\end{matrix} \qquad X = \begin{matrix}{X}_{w} \\ {Y}_{w} \\ {Z}_{w}\end{matrix}$$

where u and v are the pixel coordinates in the image and X_{w}, Y_{w} and Z_{w} are the world coordinates. The point x_{b}, projected to a point X_{b} on the ground plane can be obtained by applying the pseudo-inverse of matrix P to x_{b} as

$${X}_{b} = {P}^{- 1} {x}_{b} , \qquad {Z}_{b} = 0$$

The distance d_{b} from the camera to X_{b} can be calculated by simple trigonometry equations.

3. Starting at point X_{b}, an orthogonal line Xₗ can be created and back projected to the image plane with coordinates (uₗ, vₗ), where vₗ is set equal to the vₕ. The equation,

$${v}_{h} = P [ \begin{matrix}{X}_{l} \\ 1\end{matrix} ]$$

is solved with respect to height Zₕ. Xₗ is an approximated projection of the image point xₕ to the corresponding world coordinate Xₕ on the object. The distance \hat{d}ₕ from the camera to Xₗ can once again be calculated by simple trigonometry equations.

It should be noted that, in other embodiments, the projections need not be orthogonal, as with the case of the orthogonal line Xₗ. For instance, orthogonal projections may be employed in situations in which the object in question is substantially upright, such as a person standing. In other situations, other lines may be used: for a person lying down, the line may be parallel to the ground plane of the world coordinate system; for a person leaning, the line may be angled vis-á-is the ground plane of the world coordinate system.

4. The amount of privacy applied can be formulated as a linear function of the distance from a point to the camera as,

$$F ( d ) = f$$

where f is the amount of privacy. This can for example be a kernel size when using pixelation over an object. The distances of the points on the object between x_{b} and xₕ can be estimated by taking a linear function,

$$d ( v ) = v \frac{{d}_{h} - {d}_{b}}{{v}_{h} - {v}_{b}}$$

Where v is the y-coordinate of the point on the object. Once all the associated distances for the image points on the object are calculated, privacy can be applied.

Referring to FIG. 5, shown is an illustration of an image projection according to one embodiment of the present teachings. There are a camera, an object, and a line orthogonal to the ground plane. xₕ is the image projection of the world coordinate points Xₗ and Xₕ. x_{b} is the image projection of the point X_{b}. dₕ and d_{b} are the distances between the camera and the points Xₕ and X_{b}.

As appreciated by one skilled in the art, variants and alternative implementations could be pursued using these teachings. For example, it is possible to obtain an approximation of Xₕ with methods other than back projecting an orthogonal line starting at X_{b} on the ground to the image plane. One alternative way is projecting xₕ to the point Xₗ lying on a plane, orthogonal to the ground plane, and intersecting point X_{b}. With this approach, xₕ can be projected to the world coordinate Xₗ. The present teachings may use a projection of the points x_{b} and xₕ to the world coordinates on the object, but the present teachings are not bound to a specific method. Moreover, the Xₕ and X_{b} coordinates may be approximations of the world coordinates of the object and do not need to be exact to leverage the advantages of the present teachings.

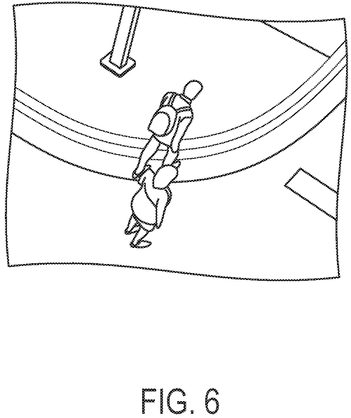

Referring to FIG. 6, shown is an illustration of two people overlapping each other in the image plane. In some cases, where it is hard to distinguish between objects, image points (e.g., x_{b} and xₕ in FIG. 5) can come from different objects. This can result in an unnecessarily high amount of privacy due to an overestimated height of the combined objects. To improve privacy in this scenario, a limit can be made on privacy for certain types of objects.

For example, in a scenario where there are many people in an image and the height Zn of the orthogonal line is estimated to be 4 m, it could be because of people overlapping one another as in FIG. 6. It is then possible to apply one of the existing privacy methods discussed in earlier sections for points over the threshold. One strategy for this scenario is to apply privacy, determined by the image coordinate of the object, for all pixels that lie above a certain point, e.g., 2 m. Adequate privacy will be applied for the first object and the rest of the objects will have an error that is associated with the privacy methods used above the threshold. This approach will still have an advantage due to the lower amount of error from the first object.

As appreciated by one skilled in the art, thresholds could be provided at varying lengths on an object, e.g., 5%, 10%, 15%, 20%, 25%, 30%, 35%, 40%, 45%, 50%, etc. The threshold could include applying a certain level of privacy above the threshold (e.g., mask a person's face that may be typically top 15% of body) or below the threshold (e.g., no mask below the face). Thresholds may also be based on anticipated object sizes (e.g., standard license plate, average person height, etc.), as would be appreciated by one skilled in the art.

In some cases, an object may be at an edge of the image, for example, one can only see the upper half of a person. In such a case, one can use a pre-defined height h to project the xₕ to Xₕ as,

$${x}_{h} = P [ \begin{matrix}{X}_{h} \\ 1\end{matrix} ] , {Z}_{h} = h$$

The height h can cover all variations of heights for this object to help assure privacy. From the x and y values of Xₕ, one can back project an orthogonal line to the v_{b} value, similar as for Xₕ in the normal case.

In one embodiment, the present teachings may set a target resolution for pixelation. For example, target resolution may be 10 pixel/m. If there is a license plate that is 1×1 meter (in world coordinates), the pixelated image of the plate will then have 10×10 pixels. This would be true no matter where the 1×1 meter plate is in the world. The further away the plate is, the smaller it becomes but the pixels used in the image will also shrink. One skilled in the art appreciates that any target resolution may be used in accordance with the present teachings. For example, the target resolution could be 1, 2, 3, 4, 5, 10, 15, 20, 25, 30, 35, 40, or 50 pixels per meter, although not limited thereto.

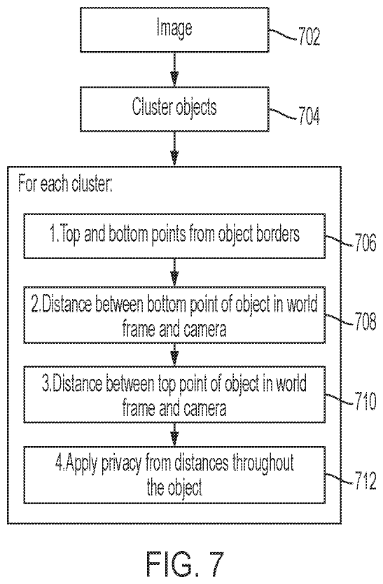

Referring now to FIG. 7, shown is a flowchart according to one embodiment of the present teachings. An image 702 (e.g., frame of a video stream, etc.) is to be processed for privacy, for instance by applying a privacy mask to the image. The privacy mask may serve to provide adequate privacy to persons or other objects in the image, for instance in accordance with local regulations, or in order to limit liability for the entity entrusted with the video stream. In different embodiments, the privacy mask may operate by pixelation, blurring, color splotches, or any other suitable approach.

Objects (or object clusters) are identified 704. Objects or object clusters may be identified in a variety of suitable fashions, including edge-finding techniques, machine-learning-based techniques, or the like. For each object (or object cluster), one or more elements of the geometry of the object is identified. In some embodiments, the top and bottom points may be identified 706 (e.g., using object borders, bounding box, etc.). Other elements of the geometry of the object may also be determined, including a depth of view of the object, an orientation of the object, a depth map for the object, or the like.

The distance between the camera acquiring the image and the bottom point may be calculated 708. The distance between the camera acquiring the image and the top point may be calculated 710. A privacy mask may then be applied throughout part or all of the object 712. In some embodiments, the object as a whole is masked; in some other embodiments, only part of the object is masked. The application of the mask may be based on the distance between the camera acquiring the image and different points on the object, or between the camera acquiring the image and different portions of the object, as appropriate. In some embodiments, the application of the mask may scale linearly between the top point and the bottom point of the object. In some other embodiments, distances between the camera and various points across the object may be determined, either by applying similar techniques to those described hereinabove, or by using interpolation or other similar techniques. In some cases, the quantity of points for which the distance to the camera is determine varies based on the type of object to which the mask is applied. The application of the mask may scale linearly between any two adjacent points on the object or may be applied in other fashions. Other approaches are also considered.

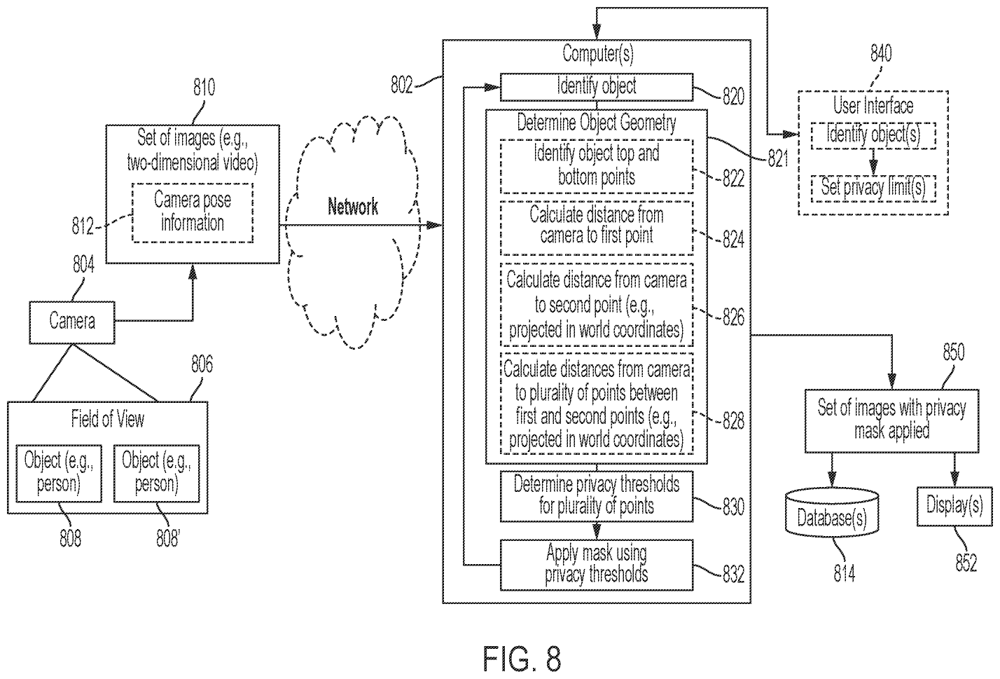

Referring now to FIG. 8, shown is one embodiment of a system according to the present teachings. As shown, a computing system 802 may be in electronic communication with a camera 804 for providing images 810. The computer/computing system 802 may include any number of computers/processors, which may communicate with each other over a network and rely on distributed computing resources. The computer 802 may typically be in the form of one or more servers.

The camera 804 may be part of a video surveillance system (e.g., one of a number of cameras) that can image objects 808, 808′ in a field of view 806. The objects may be, for example, people walking through the field of view 806, vehicles traversing the field of view 806, or any other physical thing. The imager 804 (e.g., camera) may provide one or more images 810 (e.g., video) to the computing system 802 over a network, such as the Internet. Camera pose information 812 (e.g., orientation, etc.) may also be provided.

The computer 802 may include software executing on computer readable media that may be logically (but not necessarily physically) identified for particular functionality (e.g., functional modules). An object identifier 820 may identify objects in an image. A geometry determiner 821 may determine the geometry of the object for applying privacy.

In one embodiment, the geometry determiner 821 may include a point identifier 822, e.g., for determining top and bottom points on the object. A distance calculator 824 may calculate the distance to the first point on the object and a distance calculator 826 may calculate the distance to the second point on the object. A distance calculator 828 may calculate further distances to the object between the first and second points.

A privacy determiner 830 may determine privacy thresholds for a plurality of points on the object using its calculated geometry. A mask applier 832 may apply a mask to the object using the privacy thresholds. In this way, a single object may have different privacy thresholds applied based on, for example, object location (e.g., depth) and/or orientation, although not limited thereto.

The computing system 802 may be in electronic communication with a datastore (e.g., database 814) that may store images (e.g., videos) and other information on objects, cameras, user interfaces, etc., as appreciated by one skilled in the art. Images 850 (e.g., with privacy mask applied) may be stored in the database 814 and displayed on one or more displays/monitors 852.

A user interface 840 may provide an interface for a user to operate functionality of the computing system 802, e.g., by identifying objects, setting privacy limits and thresholds, etc., as would be appreciated by one skilled in the art.

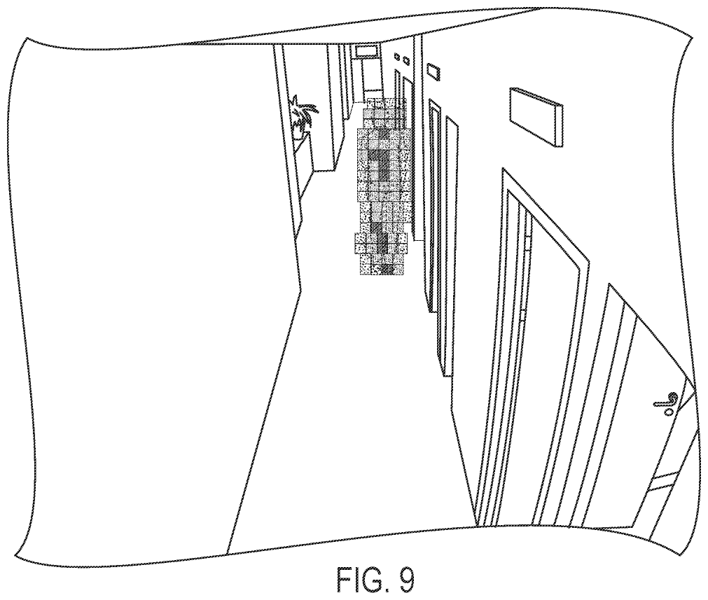

Referring to FIG. 9, shown is an illustration of an example pixelation according to the present teachings. A person is walking through a field of view and has been pixelated in order to protect privacy. This pixelation approach uses a distance-based perspective, in which portions of the person closer to the camera (e.g., their back leg and foot) are pixelated differently than portions of the person further from the camera (e.g., their torso and head), although not limited thereto.

While the present teachings have been described above in terms of specific embodiments, it is to be understood that they are not limited to these disclosed embodiments. Many modifications and other embodiments will come to mind to those skilled in the art to which this pertains, and which are intended to be and are covered by both this disclosure and the appended claims. It is intended that the scope of the present teachings should be determined by proper interpretation and construction of the appended claims and their legal equivalents, as understood by those of skill in the art relying upon the disclosure in this specification and the attached drawings.

What is claimed is:

1. A video system, comprising:
a set of images generated by a camera;
a computing system adapted to apply a mask to an object in the set of images;
the computing system adapted to identify a geometry of the object in an image from the set of images;
the computing system adapted to determine privacy thresholds for each of a plurality of points on the object in the image using the geometry of the object;
the computing system adapted to apply the mask to the object in the image using the privacy thresholds, such that the mask provides different privacy at different points on the object.

2. The system of claim 1, wherein the geometry comprises a depth of view of the object.

3. The system of claim 2, wherein the depth of view is determined using projections of points on the object in the image to world coordinates.

4. The system of claim 3, wherein:
the projections are determined by:
identifying a first point and a second point on the object;
calculating a first point distance from the camera to a projection of the first point on a ground in world coordinates;
calculating a second point distance from the camera to a projection of the second point in world coordinates, the projection of the second point on an orthogonal that is orthogonal to the ground at the projection of the first point;
calculating distances from the camera to the plurality of points, the plurality of points along the orthogonal from the projection of the first point to the projection of the second point, using the first point distance and the second point distance;
the privacy thresholds for each of the plurality of points are determined using their associated distances.

5. The system of claim 4, wherein the calculating of distances from the camera to the plurality of points comprises employing interpolation from the first point distance and the second point distance to the plurality of points.

6. The system of claim 4, comprising selecting a quantity of points to compose the plurality of points based on the type of object to which the mask is applied.

7. The system of claim 1, wherein the geometry comprises an orientation of the object.

8. The system of claim 7, wherein the orientation includes one or more expected sizes of the object.

9. The system of claim 1, wherein the computing system comprises a plurality of processors in communication over a network.

10. A video surveillance system, comprising:
the system of claim 1;
a plurality of monitors;
a plurality of cameras;
wherein the set of images includes a live video stream from one of the plurality of cameras; and
the mask includes pixelation.

11. The system of claim 10, wherein:
the object includes a person;
the mask obscures a face of the person.

12. The system of claim 1, wherein:
a limit is applied to at least one of the privacy thresholds using a type of the object;
the limit includes applying less or no privacy below a certain height on the object, such that an unnecessarily high amount of privacy is avoided if the object includes overlapping objects.

13. The system of claim 1, wherein:
a limit is applied to at least one of the privacy thresholds using a type of the object;
the limit includes applying privacy above a certain height on the object, such that an unnecessarily low amount of privacy is avoided if the object is not completely in the image.

14. A video system, comprising:
a set of images generated by a camera;
a computing system adapted to apply a mask to an object in the set of images;
the computing system adapted to identify a geometry of the object in an image from the set of images;
the computing system adapted to determine privacy thresholds for each of a plurality of points on the object in the image using the geometry of the object;
the computing system adapted to apply the mask to the object in the image using the privacy thresholds, such that the mask provides different privacy at different points on the object;
the geometry includes an orientation of the object and/or a depth of view of the object.

15. The system of claim 14, wherein the depth of view is determined using projections of points on the object in the image to world coordinates.

16. The system of claim 14, wherein the orientation includes one or more expected sizes of the object.

17. A video surveillance system, comprising:
the system of claim 14;
a plurality of monitors;
a plurality of cameras;
the set of images includes a live video stream from one of the plurality of cameras;
the mask includes pixelation.

18. The system of claim 14, wherein:
the computing system is adapted to:
identify a first point and a second point on the object;
calculate a first point distance from the camera to a projection of the first point on a ground in world coordinates;
calculate a second point distance from the camera to a projection of the second point in world coordinates, the projection of the second point on an orthogonal that is orthogonal to the ground at the projection of the first point;
calculate distances from the camera to the plurality of points, the plurality of points along the orthogonal from the projection of the first point to the projection of the second point, using the first point distance and the second point distance;
the privacy thresholds for each of the plurality of points are determined using their associated distances.

19. The system of claim 18, wherein
the first and second points are identified using a bounding box on the object;
the first point is a bottom point on the object and the second point is a top point on the object;
the privacy thresholds are determined using a linear function of distances to the camera.

20. The system of claim 14, wherein:
the camera has an associated projection matrix P as,
$$x = P [ \begin{matrix}X \\ 1\end{matrix} ] ,$$
$$with ,$$
$$x = \begin{matrix}u \\ v\end{matrix} \qquad X = \begin{matrix}{X}_{w} \\ {Y}_{w} \\ {Z}_{w}\end{matrix}$$
where u and v are pixel coordinates in an image,
X_{w}, Y_{w} and Z_{w} are world coordinates,
and point x_{b}, projected to point X_{b} on the ground can be obtained by applying the pseudo-inverse of matrix P to x_{b} as
$${X}_{b} = {P}^{- 1} {x}_{b} , \qquad {Z}_{b} = 0 ;$$
the orthogonal, Xₗ, is back projected to an image plane with coordinates (uₗ, vₗ), where vₗ is set equal to vₕ and the equation,
$${v}_{h} = P [ \begin{matrix}{X}_{l} \\ 1\end{matrix} ]$$
is solved with respect to height Zₕ, where Xₗ is an approximated projection of image point xₕ to a corresponding world coordinate Xₕ on the object;
the privacy thresholds are formulated with function,
$$F ( d ) = f$$
where f is an amount of privacy, and distances from the camera to the plurality of points between x_{b} and xₕ are estimated with function,
$$d ( v ) = v \frac{{d}_{h} - {d}_{b}}{{v}_{h} - {v}_{b}}$$
where v is a y-coordinate of a point on the object.

21. A method of applying privacy to an image, comprising:
providing a set of images generated by a camera;
providing a computing system adapted to apply a mask to an object in the set of images;
identifying with the computing system a geometry of the object in an image from the set of images;
determining privacy thresholds for each of a plurality of points on the object in the image using the geometry of the object;
applying the mask to the object in the image using the privacy thresholds, such that the mask provides different privacy at different points on the object;
the geometry includes an orientation of the object and/or a depth of view of the object.

22. The method of claim 21, wherein the depth of view is determined using projections of points on the object in the image to world coordinates.
